(19) United States
(12) Patent Application Publication
(10) Pub. No.: US 2012/0096830 A1
(43) Pub. Date: Apr. 26, 2012

(54) TURBINE AND METHOD THEREOF

(75) Inventor: Sundaralingam Manoharan, Tamil Nadu (IN)

(73) Assignee: Vaigunth Ener Tek (P) Ltd., Channai (IN)

(21) Appl. No.: 13/378,291

(22) PCT Filed: Jun. 24, 2010
(86) PCT No.: PCT/IN10/00433

§ 371 Date: Dec. 14, 2011

(30) Foreign Application Priority Data
Jul. 17, 2009 (IN) 1699/CHE/2009

(51) Int. Cl. F02K 1/00; F02K 1/78

(52) U.S. Cl. 60/204; 60/770

(57) ABSTRACT

The present disclosure relates to an improved and more efficient turbine deployed in the generation of thermal energy. The improved turbine comprises aerodynamic blades and supersonic nozzles to generate impulse and reaction forces which results into higher efficiency.

### TECHNICAL FIELD

The present disclosure relates to the field of Organic Rankine engine and more specifically to an improved and more efficient turbine deployed in the generation of thermal power through solar energy, bio-mass, bio-fuel, process waste heat, or geothermal heat.

### BACKGROUND

In the background of fast-depleting fossil-fuels, non-conventional energy is gaining rapid prominence. Amongst the various alternatives, this invention is targeted for the solar thermal power generation and for hybrid power generation using bio-mass, bio-fuel, natural gas, process waste heat or geothermal energy.

One of the ways of thermal power generation with CSP (Concentrating Solar Power) or a hybrid combination of CSP and bio/gas/waste-heat is through the principles of the Organic Rankine Cycle (ORC). The proposed invention can be deployed in the generation of such thermal power based on the principles of ORC.

Organic Rankine Cycle (ORC) is a thermo-dynamic cycle in which an organic fluid is evaporated (to saturated state) and expanded through a turbine (Rankine Cycle) to generate power. The fluid is pumped to a boiler where it is evaporated, is passed through a turbine and is finally re-condensed to start the cycle all over [FIG. 1]. The liquid-vapor phase change, or boiling point, occurs at a lower temperature than the water-steam phase change. The organic fluids can be used at low temperature in the range of 120° C. to 70° C. and do not get superheated, resulting in a higher efficiency of the cycle.

The Organic Rankine Cycle (ORC) is similar to the cycle of a conventional steam turbine, except for the fluid that drives the turbine is environmentally friendly organic fluid, with a low boiling point. This allows the system to run efficiently at low temperature heat sources to produce electricity in a wide range of power outputs.

In biomass power plants, for example, ORC helps overcome the high investment costs for steam boilers due to low working pressures in ORC power plants. ORC is especially useful in regions that have relatively limited availability of input fuel. In such regions, an efficient ORC power plant is possible for smaller sized industrial units.

In the case of solar energy, the ORC allows a lower collector temperature, a better collecting efficiency (reduced ambient losses) and hence the possibility of reducing the size of the solar field. Many different types of CSP systems are possible, including combinations with other renewable and non-renewable technologies. Hybrid plants, a combination of fossil fuels and solar energy, help produce a reliable peak-load supply, even on less sunny days. Some of the more widely used CSP technologies are parabolic troughs, linear Fresnel systems, central receivers (aka solar towers) and parabolic dishes.

### SUMMARY OF THE DISCLOSURE

The shortcomings of the prior art are overcome and additional advantages are provided through the provision of a system as claimed in claim 1.

Additional features and advantages are realized through the techniques of the present disclosure. Other embodiments and aspects of the disclosure are described in detail herein and are considered a part of the claimed disclosure.

An exemplary embodiments provides an improved turbine for generating solar thermal energy comprising aerodynamic blades in turbine rotor configured to reduce flow drag and convergent-divergent nozzle in turbine stator configured to generate supersonic flow leading to reaction forces.

In an exemplary embodiment, the turbine utilizes twisted blades to operate at predetermined capacity and temperature.

In an exemplary embodiment, curvature shape of the blade arrangement generates impulse forces and pressure behind the aerodynamic shape generates reaction force.

In an exemplary embodiment, trailing edge of the blades is configured to obtain aerodynamic thrust force.

In an exemplary embodiment, the turbine operates in the range from about 1 KW to about 1 MW.

In an exemplary embodiment, the turbine is capable of working in the range from about 80° to about 250° C. temperature and in the range from about 0.7 to about 15 Bar pressure.

In an exemplary embodiment, the turbine works at low RPM in the range from about 3000 RPM to about 10,000 RPM, preferably 4500 RPM and matches with the alternator RPM without any gearbox reduction.

In an exemplary embodiment, the turbine operates at low flow rates in the range from about 100 gms/sec to about 10 kg/sec.

In an exemplary embodiment, the turbine provides about 80% efficiency in-terms of output energy at 500 gms/sec flow rate.

In an exemplary embodiment, the turbine generates thermal energy at predetermined temperature preferably at 80° C. from plurality of resources selected from a group comprising concentrating solar thermal energy, bio gas, bio mass, geothermal hot fluid, natural gas, cooking gas and industrial waste unit or any combinations thereof.

In an exemplary embodiment, multi-stage turbine preferably three stage turbine is utilized to generate solar thermal energy at predetermined efficiency.

Another exemplary embodiment provides a method of generating solar thermal energy using improved turbine, said method comprising acts of generating aerodynamic thrust force to fluid vapor using trailing edge of the turbine blades; receiving aerodynamically thrusted fluid vapor inside the turbine through convergent-divergent nozzle; turning the received vapor inside housing to enter flow into stator of the turbine and thereafter into rotor of the turbine; and rotating around the flow in the housing to exit the flow diametrically outwards the turbine to generate solar thermal energy

In an exemplary embodiment, the solar thermal energy is generated using multi-stage turbine preferably three stage turbine.

In an exemplary embodiment, the aerodynamic thrust force travels opposite to rotational direction of the turbine to provide additional thrust for generating predetermined amount of power per stage.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristic of the disclosure are set forth in the appended claims. The invention itself, however, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawings in which:

FIG. 1 is an exemplary diagram which illustrates the working principle and operation of Organic Rankine cycle (ORC).

FIG. 2 is an exemplary diagram which illustrates arrangement of Concentrating Solar Power (CSP) Organic Rankine cycle (ORC).

FIG. 3 is a plot of collector efficiency versus fluid temperature indicating the optimal range for the ORC engine (source: Sandia National Laboratories, USA)

FIG. 4 is an exemplary diagram which shows blade profile that has been chosen with the Aerodynamic profile of NACA-0006 (National Advisory Comity for Aeronautics).

FIG. 5 is an exemplary picture of a standard radial turbine.

FIG. 6 is an exemplary diagram which illustrates an improved turbine in accordance with an aspect of the subject disclosure.

FIG. 7a is an exemplary diagram illustrating presence of supersonic nozzle in turbine stator of improved turbine in accordance with an aspect of the subject disclosure.

FIG. 7b is an exemplary diagram illustrating arrangement of aerodynamic blades in turbine rotor of improved turbine in accordance with an aspect of the subject disclosure.

FIG. 8 is an exemplary diagram showing assembled diagram of improved turbine showing arrangement of supersonic nozzle in turbine rotor and aerodynamic blades in turbine rotor in accordance with an aspect of the subject disclosure.

FIG. 9 is an exemplary diagram illustrating assembly of three stage turbine showing flow path of fluid vapor.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION OF THE DISCLOSURE

In the following detailed description, reference is made to the accompanying drawings, which forms a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Conventional solar thermal (CSP) power generation requires almost perfect solar conditions; vast expanse of open space, and hence must be installed at a great distance from the customers. Therefore, such a requirement demands the additional expense of transmitting and distributing electricity. The proposed approach makes it viable for compact, distributed and modular power generation, just like PV (Photovoltaic cells).

Scaling up and large scale electricity generation has been the way to cost reduction in CSP, and no small scale operation less than a few MW are feasible with conventional CSP. It may be noted that in the range from 200 KW to 1 MW (and above), solar generation is possible only with axial turbine. But they suffer from the disadvantages of high RPM and high temperature. In the range of 20 KW to 100 KW standard radial turbines are deployed; they also suffer from disadvantages of high RPM, high temperature and high pressure. The proposed invention brings down the size to as low as 10 KW (to be extended to operate in the range from 1 KW to 1 MW in future).

Worldwide, CSP technology development is primarily focused on components like reflectors, collector size, receiver efficiency, thermal storage, and heat transfer fluids. The proposed disclosure takes the route of developing a novel engine cycle technology for low capacity power plants. The present approach discussed in the instant disclosure makes it possible to have roof-top CSP, which is a major breakthrough in solar thermal power generation.

The newly designed turbine proposed in the present disclosure has the ability to work in different hybrid environments. For example, it can work with solar thermal electrical plant, Bio gas, solid Biomass, industrial waste heat and geothermal heat.

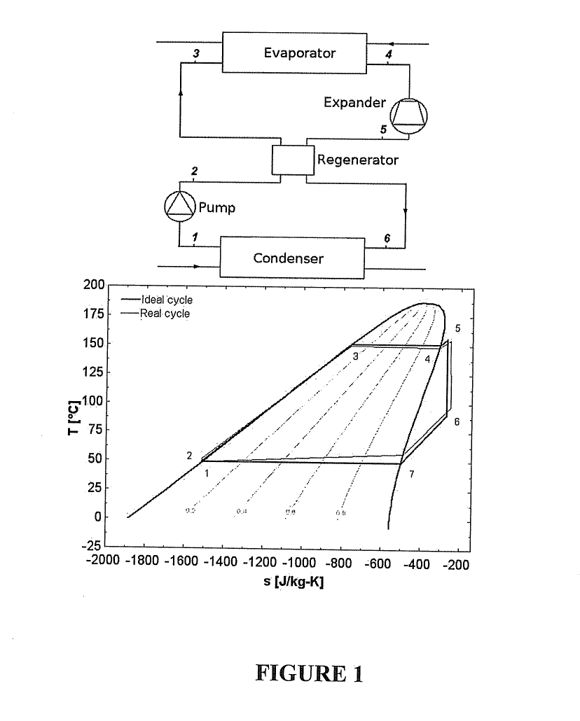

FIG. 1 shows the working principle of the ORC. The working principle of the organic Rankine cycle is the same as that of the Rankine cycle. The working fluid is pumped to a boiler where it is evaporated, passes through a turbine and is finally re-condensed.

In the ideal cycle, the expansion is isentropic and the evaporation and condensation processes are isobaric.

In the real cycle, the presence of irreversibilities lowers the cycle efficiency. Those irreversibilities mainly occurs due to
During the expansion: Only a part of the energy recoverable from the pressure difference is transformed into useful work. The other part is converted into heat and is lost. The efficiency of the expander is defined by comparison with an isentropic expansion.
In the heat exchangers: The working fluid takes a long and sinuous path which ensures good heat exchange but causes pressure drops that lower the amount of power recoverable from the cycle.

In the case of a working fluid is “dry fluid”, the cycle can be improved by the use of a regenerator. Since the fluid has not reached the two-phase state at the end of the expansion, its temperature at this point is higher than the condensing temperature. This higher temperature fluid can be used to preheat the liquid before it enters the evaporator. A counter-flow heat exchanger is thus installed between the expander outlet and the evaporator inlet. The power required from the heat source is therefore reduced and the efficiency is increased.

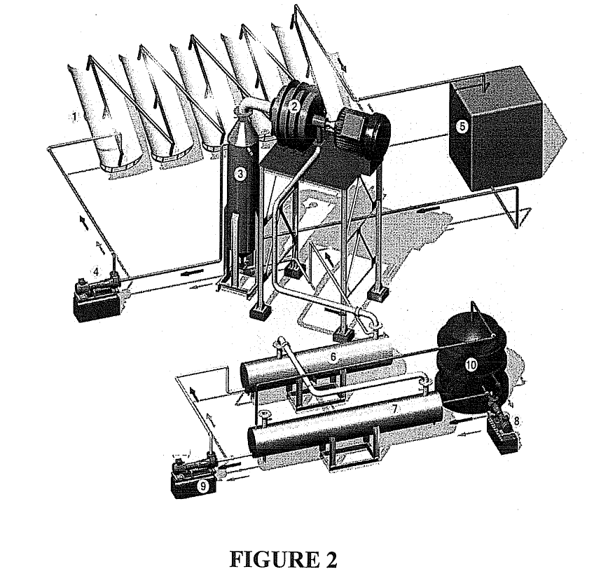

FIG. 2 is a schematic representation of the system that works on Concentrated Solar Power (CSP) Organic Rankine Cycle, which is a well-established and proven technology. A heat carrying medium (oil) is heated through the pipes (red loop in the schematic) on which solar radiation is concentrated through the parabolic troughs (1). An organic fluid (green loop) is fed to the boiler (3) where it is evaporated by the heat from the circulating hot oil and expanded through our turbine (2) to generate direct AC power at the alternator. The fluid is finally re-condensed in regenerator (6) and condenser (7) to start the cycle all over. The cooling fluid (white loop) is finally cooled in cooling tower (10). For night-time operation, hot fluid can be stored in a storage tank (5) for use when the sun sets down. In case of no availability of the sun for a few days, the heating of the working fluid in the evaporator (3) can be provided by alternative methods such as bio-fuel, biomass, natural gas, LPG, etc.

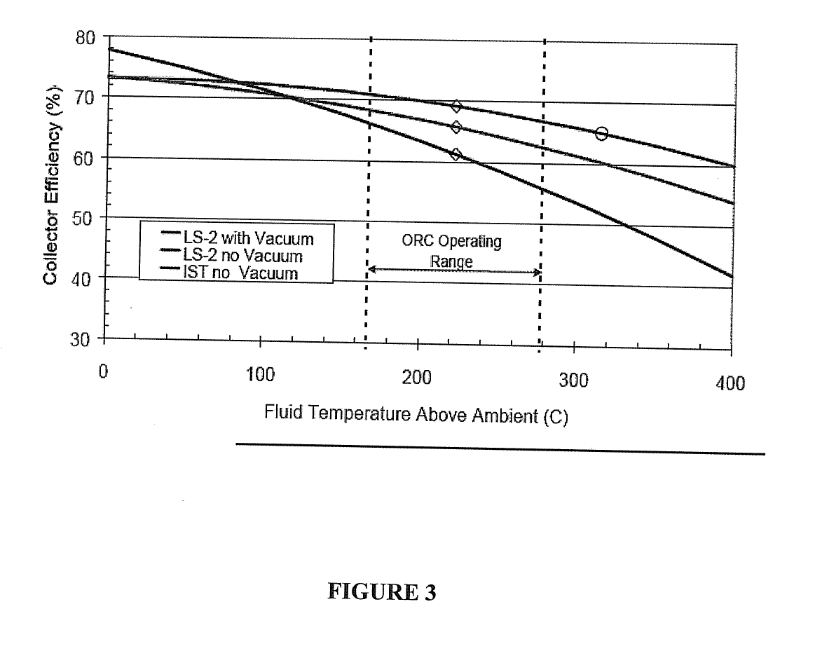

Referring now to FIG. 3, it can be seen from the plot that (Courtesy: Sandia National Laboratories, USA), the optimal efficiency of solar ORC engines is obtained between 80-150 deg C. But the biggest challenge till now has been the non-availability of a suitable turbine and parabolic reflectors that can operate in this range. The proposed approach is towards creating a suitable turbine that can operate in this optimal range.

Traditional radial turbines have several advantages. They are as follows
Due to the compact arrangement of the turbine, thermal losses are minimized.
The turbine blade has a constant untwisted profile along its length to provide uniform radial flow. High precision blades can therefore be obtained from low cost manufacturing methods, and a simple and accurate aerodynamic analysis can be used for the design.
In most cases, full admission can be used on all stages due to the radial arrangement, which puts the low volumetric flow stages at a small diameter.
With almost negligible change to the turbine housing, the power output of a given unit can be adjusted by changing the turbine blade heights by a proportionate amount.

The turbine proposed in the present disclosure builds on the advantages of a Radial turbine and incorporates the following enhancements. Improvement to such turbines would represent a significant advancement of the art.

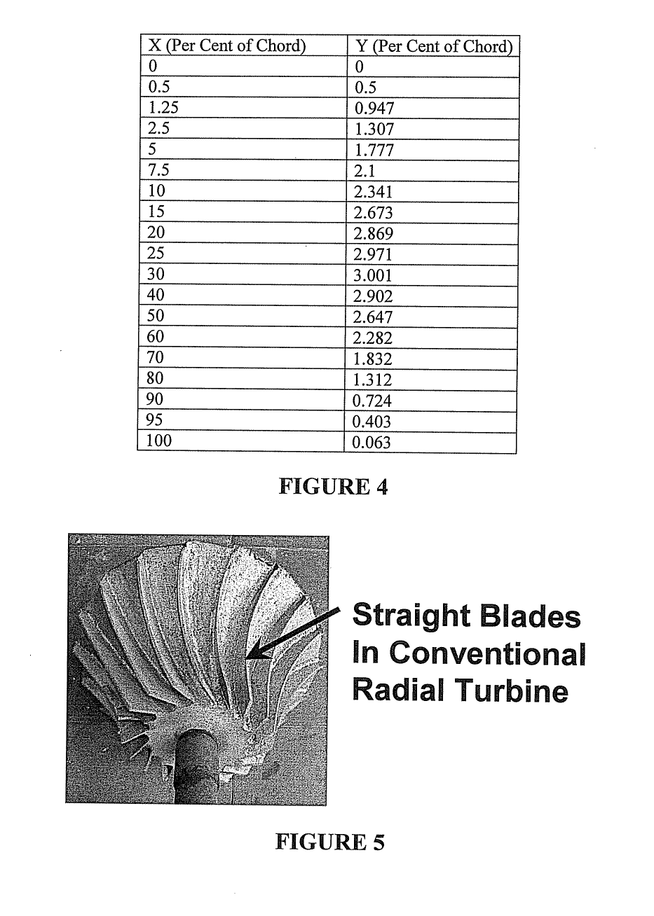

The proposed disclosure is a newly designed turbine which will work as a 50% Impulse and 50% Reaction turbine. The blade profile of the turbine has been chosen with the Aerodynamic profile of NACA-0006 (National Advisory Comity for Aeronautics) as indicated in FIG. 4 to minimize the losses. All NACA blades are designed and optimized after careful calculations and experimentations so that losses are minimized and hence efficiency maximized. These are proven profiles, and hence are standard.

Conventional or standard radial turbines as shown in FIG. 5 have compact straight blades that provide only impulse force to rotate the turbine and generate power. The proposed invention is a combination of radial and axial designs.

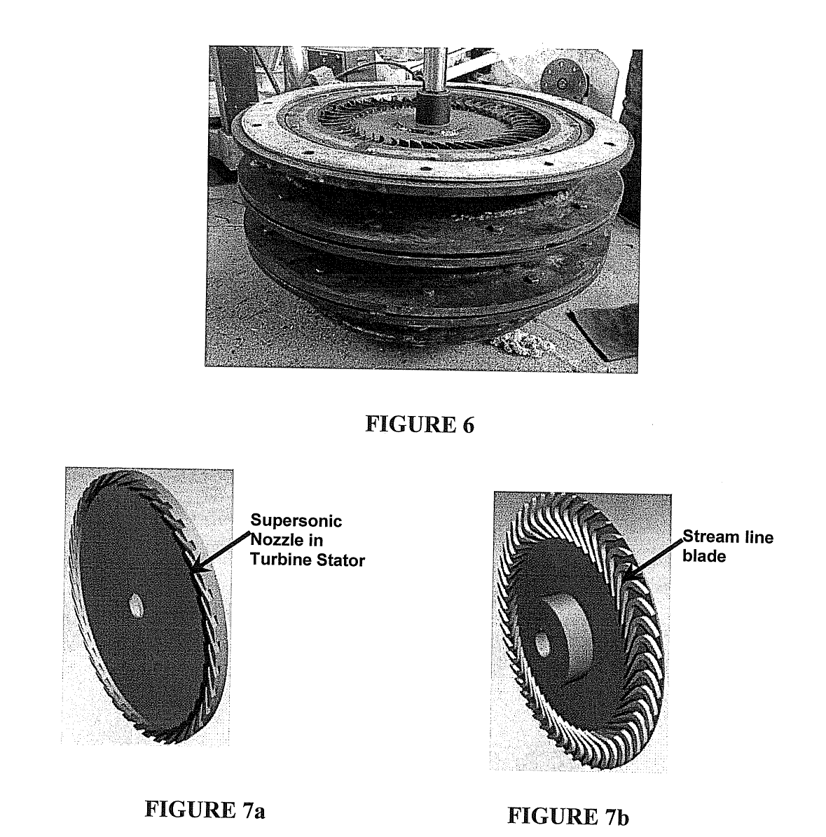

Referring now to FIG. 6 a newly designed turbine is illustrated comprising aerodynamic blades and twisted blades. The aerodynamic blades have been used instead of compact blades to reduce the flow drag and to improve the efficiency.

Further, the newly designed turbine utilizes twisted blades used in axial turbines. With this design, it is capable to operate the new improved turbine with low capacity at low temperature. The blade arrangements are so designed such that it gets both impulse and reaction forces. Impulse force is provided by curvature or the twisted blades, while the reaction forces are provided by low pressure behind the aerodynamic shape. This results in higher efficiency.

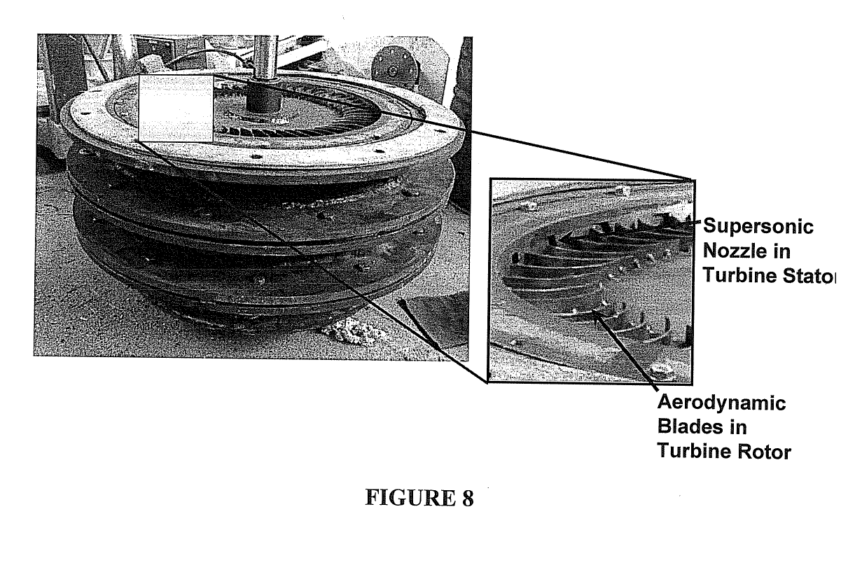

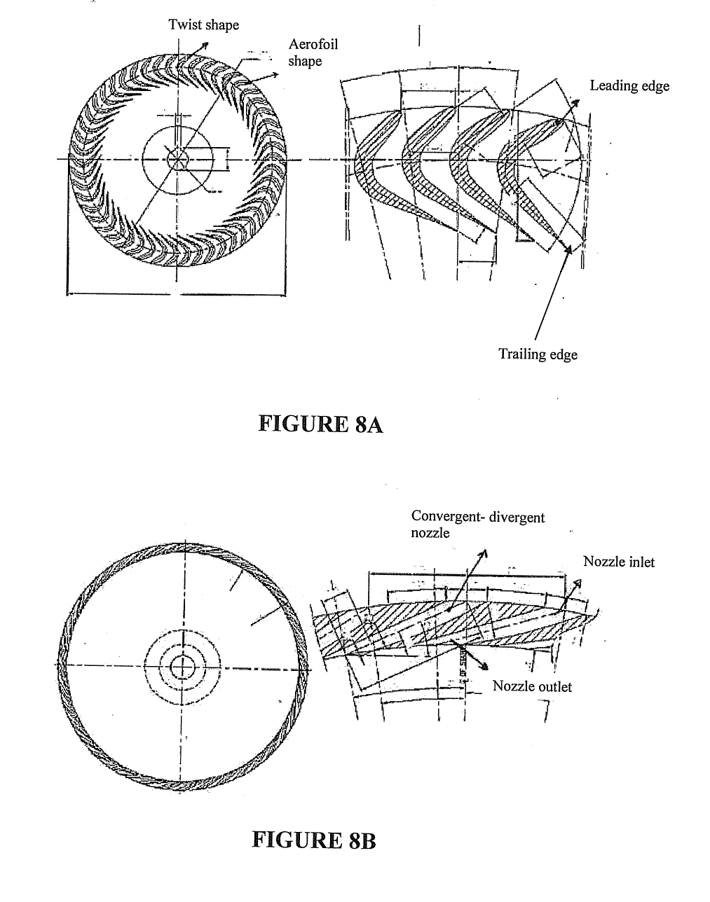

In one embodiment, the convergent-divergent nozzles or supersonic nozzles are provided in newly designed turbine to get supersonic flow. This would leads to reaction forces and hence improves efficiency. The stator is designed in such a way as to achieve a supersonic flow at the exit of the stator nozzles which is a converging-diverging nozzle. The design of the turbine stator is illustrated in FIG. 7a. In contrast, the traditional radial turbine includes the inlet which is a simple converging nozzle and the flow is only choked at the nozzle exit. Referring back to supersonic nozzle at stator, the supersonic flow at the exit of the proposed stator creates higher efficiency. When the supersonic flow enters the rotor blade, the flow is accelerated through aerodynamic blades to achieve additional thrust and reaction, which further improves the turbine efficiency. The design of the aerodynamic blades in turbine rotor is depicted in FIG. 7b. The combined arrangement of stator with supersonic nozzle and rotor with newly designed aerodynamic blades is shown in FIG. 8.

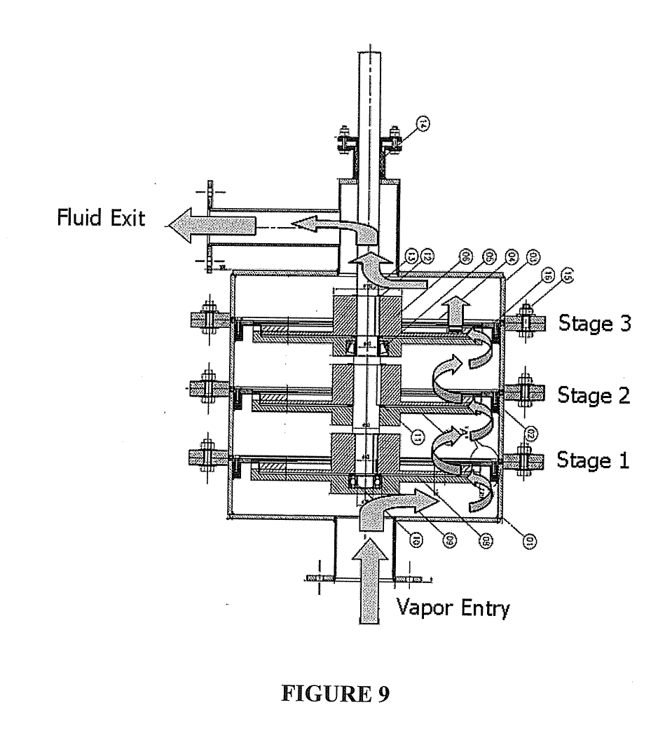

The FIG. 9 shows an assembly drawing of a 3-stage turbine in the instant disclosure. The flow path of the fluid is shown with arrow signs. Fluid vapor enters the turbine through the axial entry and turns inside the housing to enter the stator of stage 1 turbine. It passes through the stator and then the rotor of stage 1 turbine and exits stage 1 to enter the stator of stage 2. The flow cycle is repeated till the fluid finally exits from stage 3 turbine. The flow turns around in the housing to finally exit diametrically outwards at the exit.

The trailing edge of the blades is configured to get aerodynamic thrust force. The thrust force so generated leaves from the trailing edge of the blades, and travels opposite to the rotational direction of the turbine to provide additional thrust generating more power per stage. So, the overall number of stages can be reduced. It is known to person skilled in the art that Radial turbines have less number of stages than axial turbine. However, the proposed newly designed turbine has even lesser number of stages than conventional radial turbines.

Low-kW power generation requires the flow rate to be reduced, but pressure needs to be kept the same/constant because of the Rankine cycle requirement.

Therefore, the number of nozzles must be reduced which cannot be done in axial turbines. Whilst other current turbines have significant challenges in reducing the flow-rate, the turbine proposed in the present disclosure is capable of achieving this challenge with relative ease.

The turbine proposed in the present disclosure is currently designed to operate in the range about 10 KW to 50 KW. It is proposed to carry out further design changes to enable the turbine to operate over the entire range from 1 KW to 1 MW. To extend the range from 1 KW to 1 MW, the following changes are envisaged in the design of the proposed turbine.
changes in turbine's dimension such as the diameter. The diameter of the turbine around 300 cm to around 1000 cm
changes in the Number of Stages.
changes in the number of nozzle and its angle
changes in the operating pressure and temperature

Lower flow rates can be achieved in radial turbines, but standard radial turbines will give very poor efficiency, and therefore is not feasible for power generation at low flow rates. The turbine proposed in the present disclosure can operate with lower flow rates and achieve higher efficiency compared to radial turbines.

The turbine proposed in the present disclosure is designed in such a way that it will work at low temperature, for example, at 80° C. and low pressure for example, at 0.7 bar. This leads to lower maintenance, allows usage of low cost materials such as aluminum, needs less insulation, and achieves higher efficiency and hence low cost of ownership.

The turbine proposed in the present disclosure is designed in such a way that it works at low RPM in the range about 3000 to about 10000, preferably at 4500 RPM. Therefore it matches the alternator's RPM without any gearbox reductions and hence results in lesser cost and higher efficiency (no gear-reduction loss).

In case of grid-connected power generation with this system, the proposed system allows the rpm to be easily varied to match the grid frequency and phase. The controls of matching and tuning are significantly simplified.

The turbine proposed in the present disclosure is designed to:
work at low temperature and low pressure leading to low maintenance, inexpensive materials, higher efficiency and low cost of ownership
to work at low RPM so that it matches the alternator RPM without any gearbox reductions and at lower cost
achieve high efficiency by a combination of enhancements such as impulse and reactive designs with modified blades
minimize thermal losses with a compact arrangement of turbine blades
achieve simple and accurate analysis using 3-Axis CNC milling machine and low-cost manufacturing of high precision blades
attain high efficiency with less number of stages than conventional radial or axial turbines
easily modify turbine nozzles to achieve required flow and pressure
provide higher efficiency at low flow rates by innovative design of blades and nozzles

The proposed turbine can be used in the following applications for power generation:
1. Concentrating Solar Thermal Power Generation—This turbine allows the use at low temperature, low pressure to achieve low flow and low power output to enable kW-level low capacity power generation. The high capacity version of the turbine can also be used for MW level power generation at very high efficiencies.
2. Low-temperature power generation with Bio-mass and Bio-fuel using ORC
3. Low-temperature power generation with natural gas and cooking gas using ORC
4. Low-temperature power generation using industrial process waste heat (steam or flue gas) using ORC
5. Low-temperature power generation from geothermal hot fluid using ORC
6. Refrigeration and air-conditioning applications using the turbine to directly run a compressor to drive refrigeration cycle
   The foregoing description of the embodiments of the disclosure has been presented for the purpose of illustration; it is not intended to be exhaustive or to limit the invention to the precise forms disclosed. Persons skilled in the relevant art can appreciate that many modifications and variations are possible in light of the above disclosure.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

We claim:

1. An improved turbine for generating solar thermal energy comprising aerodynamic blades in turbine rotor configured to reduce flow drag and convergent-divergent nozzle in turbine stator configured to generate supersonic flow leading to reaction forces.

2. The turbine as claimed in claim 1, wherein the turbine comprises twisted blades to operate at predetermined capacity and temperature.

3. The turbine as claimed in claims 1 and 2, wherein the twisted blade generates impulse forces and low pressure behind the aerodynamic blade generates reaction force.

4. The turbine as claimed in claim 1, wherein trailing edge of the blades is configured to obtain aerodynamic thrust force.

5. The turbine as claimed in claim 1, wherein the turbine operates in the range from about 1 KW to about 1 MW.

6. The turbine as claimed in claim 1, wherein the turbine is capable of working in the range from about 80° to about 250° C. temperature and in the range from about 0.7 to about 15 Bar pressure.

7. The turbine as claimed in claim 1, wherein the turbine works at low RPM in the range from about 3000 RPM to about 10000 RPM, preferably 4500 RPM and matches with an alternator RPM without any gearbox reduction.

8. The turbine as claimed in claim 1, wherein the turbine operates at low flow rates in the range from about 100 gms/sec to about 10 kg/sec.

9. The turbine as claimed in claim 1, wherein the turbine provides about 80% efficiency in-terms of output energy at 500 gms/sec flow rate.

10. The turbine as claimed in claim 1, wherein the turbine generates thermal energy at predetermined temperature preferably at 80° C. from plurality of resources selected from a group comprising concentrating solar thermal energy, bio gas, bio mass, geothermal hot fluid, natural gas, cooking gas and industrial waste unit or any combinations thereof.

11. The turbine as claimed in claim 1, wherein multi-stage turbine preferably three stage turbine is configured to generate solar thermal energy at predetermined efficiency.

12. A method of generating solar thermal energy using improved turbine, said method comprising acts of
i. generating aerodynamic thrust force to fluid vapour using trailing edge of the turbine blades;
ii. receiving aerodynamically thrusted fluid vapour inside the turbine through convergent-divergent nozzle;
iii. turning the received vapour inside housing to enter flow into stator of the turbine and thereafter into rotor of the turbine; and
iv. rotating around the flow in the housing to exit the flow diametrically outwards the turbine to generate solar thermal energy

13. The method as claimed in claim 12, wherein the solar thermal energy is generated using multi-stage turbine preferably three stage turbine.

14. The method as claimed in claim 12, wherein the aerodynamic thrust force travels opposite to rotational direction of the turbine to provide additional thrust for generating predetermined amount of power per stage.
